(19) United States
(12) Patent Application Publication
(10) Pub. No.: US 2020/0079157 A1
(43) Pub. Date: Mar. 12, 2020

(54) METHOD FOR DETECTING THE WEAR OF WEARING TIRES OF A VEHICLE AND VEHICLE

(71) Applicant: Hella KGaA Hueck & Co., Lippstadt (DE)

(72) Inventors: Hauke BAUMGAERTEL, Delmenhorst (DE); Thomas NIEMANN, Delmenhorst (DE); Carsten THUN, Bremen (DE)

(21) Appl. No.: 16/683,845

(22) Filed: Nov. 14, 2019

Related U.S. Application Data
(63) Continuation-in-part of application No. 15/017,064, filed on Feb. 5, 2016.

(30) Foreign Application Priority Data
Feb. 5, 2015 (DE) 10 2015 001 502.8

(51) Int. Cl. B60C 11/24; G01H 11/08; G01M 17/02

(52) U.S. Cl. CPC B60C 11/246; G01M 17/025; G01H 11/08; B60C 11/243

(57) ABSTRACT

In a method for detecting the wear of wearing tires of a vehicle, wherein the tires consist of an elastic material, signals are emitted by signal generators introduced into the tires, wherein only signal generators located on the tire surface emit a signal. The emitted signal is received by a sensor arranged in the vehicle, and information processed from the received signal is made available to the driver of the vehicle. Enhanced, in particular automatic measurement of the tire tread is enabled by means of such a method.

### CROSS-REFERENCE TO RELATED APPLICATIONS

This application is a Continuation-in-Part of co-pending application Ser. No. 15/017,064 filed on Feb. 5, 2016, for which priority is claimed under 35 U.S.C. § 120; and this application claims priority of Application No. 10 2015 001 502.8 filed in Germany on Feb. 5, 2015 under 35 U.S.C. § 119; the entire contents of all of which are hereby incorporated by reference.

### BACKGROUND OF THE INVENTION

### Field of the Invention

The invention relates to a method for detecting the wear of wearing tires of a vehicle, wherein the tires consist of an elastic material. The invention further relates to a vehicle having wearing tires, which are produced from an elastic material, having a wear measuring unit for the tires.

### Brief Discussion of the Related Art

The tires of vehicles, particularly motor vehicles and transport vehicles, are made of rubber or a rubber material and have a tread with grooves, scores or webs in order to enhance adhesion of the tire to the road surface. Due to the elastic rubber material, tires wear off and the tread depth decreases. As a result, driving properties are more and more degraded, especially if the tread is worn-off down to the tread base. This is why minimum tread depths are required by law in many countries.

It is known to arrange a numeric wear indicator on the tires. In this case, wear level of the tire is displayed by means of multiple numbers on the running face of the tire. These numbers indicate the tread depth and disappear bit by bit, the more the tire is worn-off.

Furthermore, manually-operable tire tread gauges are known, which are significantly more precise than said numerical wear indicators. The tire tread gauges are inserted into the tread at different locations of the tire so that the tread depth can be measured there.

### SUMMARY OF THE INVENTION

It is the object of the invention to provide a method and a device of the above type by means of which an improved, particularly automatic tread measuring is possible.

In a vehicle comprising wearing tires made of an elastic material and a wear measuring unit for the tires, the wear measuring unit comprising a plurality of signal generators integrated in at least one joint signal element arranged in a tread of the tire, wherein the signal element generates a structure-borne sound signal when the tires are worn off. When the signal element comes into contact with the street the signal element generates a structure-borne sound signal, wherein the signal element is smaller than the tread of the tire so that the signal element is able to move within the tread of the tire at least as long as it is not in contact with the street and generates a structure-borne sound signal by its movement within the tread of the tire, whereby in the vehicle a sensor for a structure-borne sound signal is provided for receiving the signal emitted by the signal generators and a signal processing unit for processing the received signals into information useful for the driver. With such a vehicle it is possible to generate useful information for the driver that the tread depth reached a critical depth and that the tire needs to be replaced soon. Preferably, the signal element which is arranged in the tread of the tire has the same cross section in a running direction of the tire.

In another preferred embodiment of the invention the signal element, which is arranged in the tread of the tire, has a width in the cross section which is smaller than width of the tread of the tire. By this measure the signal element can move in a direction vertical to the running direction of the tire within the tread and generate a structure-borne signal by its movement within the tread of the tire.

To fix the signal element within the tread of the tire, it is preferred that the signal element hat protrusions. Such protrusions are preferably at the bottom of the signal element and are directed vertical to the running direction of the tire. Preferably, in the tread of the tire, in particular at the bottom of the tread of the tire, there are recesses which correspond to the protrusions of the signal element. By this measure the signal element can be fixed with its protrusions in the corresponding recesses in the tread of the tire. In a preferred embodiment the recesses and the tread of the tire are larger than the corresponding protrusions of the signal element to further enhance and allow the movement of the signal element within the tread of the tire.

By this means it is possible to receive two kinds of signals. A signal with a smaller amplitude as long as the signal element is within the tread of the tire and does not contact the street. The signal gives the information that the signal element is still within the tread of the tire and is not lost. If the tire is worn down to the signal element, there is an additional signal which is generated by the contact of the signal element with the street. Typically, the signal has as a completely different structure and a higher amplitude than the signal generated by the movement of the signal element within the tread of the tire. The signal element itself can be composed of various steps and recesses thereby causing signals of a different kind to further differentiate between various grades of wear-off of the tire.

In a method for detecting the wear-off wearing tires of a vehicle the method comprises emitting signals by the signal elements arranged in the tire treads receiving the signals emitting from the signal elements arranged in the tire treads based on the contact of the signal element with the drive lane receiving the signal elements from the signal elements based in their movements within the tire treads and processing the information from the two kinds of received signals and making the information available to the driver. With such a method it is possible to have additional information about the signal generators. Preferably, the signals emitting from the movement of the signal element within the tire tread are used to verify that the signal elements are still in place and are actually working. If the tire has worn down so far that the signal element comes into contact with the drive lane, the signal is used to establish the grade of the wear-off of the tire. The signal element has preferably two or three protrusions which generate different signals depending on the wear-off of the tire. By this measure it is possible to differentiate between various states or grades of wear-off of the tire.

Preferably, the two kinds of received signals can be differentiated by their amplitude as the signals which based on the contact of the signal element with the drive lane is larger than the amplitude of the signal emitting from the signal element based in their movements within the tire treads. The signal emitted by the movement of the signal element in its recess can be easily distinguished from the signal emitted by the contact of the signal element to the road surface by the amplitude of the signals. The contact of the signal element to the road surface emits a signal of higher amplitude than the movement of the signal element in the recess. By the signal amplitude the state of wear of the tire could be evaluated.

In a method for detecting the wear of wearing tires of a vehicle, wherein the tires consist of an elastic material, it is provided according to the invention that signals or signal sequences are emitted by signal generators which were introduced into the tire, wherein only signal generators located on the tire surface emit a signal, that the emitted signal is received by a sensor arranged in the vehicle, and in that information processed from the received signal is made available to the driver of the vehicle. Automatic monitoring of the tire tread can be effected by means of such a method. The wear of all four wheels can automatically be checked and monitored by means of the method according to the invention. An evaluated signal may then be output to the driver. By means of such a method, it can particularly be determined that the tread depth reached a critical depth and that the tire needs to be replaced soon.

Preferably, different signals are emitted by the signal generators introduced in the tire in different depths, wherein only the signal generators located on the tire surface emit a signal. This allows displaying not only a primary signal indicating that soon a tire needs to be replaced, but differentiated grades and, for example, displaying a new tire, a worn-off tire and an inoperable tire. The differentiation can of course be elaborated further.

In another preferred further development of the invention, signal generators emitting the same signals are arranged at multiple different positions viewed over the width of the tire, so that signal generators located at places where the tire is correspondingly worn-off first are emitting a signal. This way it is considered that the tires are not worn-off in a uniform manner. Depending on the area in which a tire is worn-off first, the group of signal generators located in this area will reach the surface and generate a corresponding signal. This way, a reliable display of the worn-off tire is ensured.

Preferably, the signal generators generate a structure-borne sound signal and the structure-born sound signal is received by a piezoelectric sensor. The structure-borne sound signal is transmitted via the rim and the axis to the body. A structure-borne sound sensor, in particular a piezoelectric sensor, is arranged at the body, which sensor detects said structure-borne sound signal. The structure-borne sound signals arrive at the sensor position via the vehicle structure.

In this case, preferably frequencies in the range of 25 to 30 kHz and in the range of 50 to 60 kHz are generated and transmitted.

As an alternative, the signal generators generate an acoustic signal and the acoustic signal is preferably received by an acoustic sensor. Acoustic signals of this type can be reliably transmitted without cables from the tire to a sensor in the vehicle and are therefore particularly suitable for the method according to the invention. Frequencies generated by the signal generators are preferably greater than 30 kHz. Such frequencies are imperceptible for the human hearing and are therefore particularly suitable for the method according to the invention. The frequency of the signal naturally depends on the speed of the vehicle and the associated rotational frequency of the tires. With typical velocities above 30 km/h, the acoustic signal should have a frequency of greater than 30 kHz.

In a preferred embodiment of the invention, signal generators are arranged at different distances to one another or a different number of signal generators is arranged in the different depths of the tire so that in the different depths, the signal generators generate signals of different frequency or in a different pattern. The individual signal generators may each generate the same sound per se. The signal generators are preferably arranged in different depths. A first group of signal generators should be arranged in the outer region of the tire, so that the frequency generated by said signal generators or the signal sequence generated by said signal generators outputs an acoustic signal if the tire tread has a sufficient tread depth, i.e. typically greater than 2 mm. A second group of signal generators should be arranged in the tire below said first group and generate a second frequency or a second signal pattern, which is produced if the tires have a reduced tread depth, typically a tread depth between 1.6 mm and 2 mm. Below the signal generators of said second group should be arranged a third group of signal generators, which generates a third frequency or a third group of signals, generating an acoustic signal if an insufficient tread depth is only still available, typically a tread depth of less than 1.6 mm. The three different frequencies or groups of signals are different from one another in order that the sensor arranged in the vehicle receives a different signal from each of the said three groups of signal generators.

In the case of the information that is made available to the driver of the vehicle the signal of the first group of signal generators would be displayed with a green indicator, the signal of the second group of signal generators would be displayed with a yellow indicator and the signal of the third group of signal generators with a red indicator. With the signal of the yellow indicator, preferably the distance of kilometers that can probably be covered within the yellow region could be indicated as well. Preferably, other groups of signal generators can be integrated in the tire in order to further differentiate the information for the driver. The signal generators of the second group, i.e. the ones having the yellow indicator, are the most important signal generators. If applicable, exclusively such signal generators could be used which range in the “yellow region” and emit a signal in the case that the tires are worn-off so far that the tread depth is still in the allowed range but will soon no longer be in the allowed range, i.e. the tires need to be replaced soon.

When evaluating the received acoustic signals, preferably the speed of the vehicle is considered. On the one hand, the frequency emitted by the signal generators depends on the distance of the signal generators to one another, on the other hand the frequency generated therefrom also depends on the speed of the vehicle and thus the rotational frequency of the tires. The signal generators generate a sound with every contact to the ground, which is then detected.

In a particularly preferred embodiment of the invention, the signal generators extend over a certain depth, so that the signal generators located closest to the tire surface constantly generate a signal, i.e. continue generating a signal if additionally signal generators of the next deeper layer are emitting a signal. This means that two signal generators are provided, for example, which extend over all three depth regions, and additionally another signal generator is provided, which extends only over the middle and the lower layer, and additionally another signal generator is provided which extends only over the lowest layer. This order results in a signal having a sound sequence of two sounds in the outer “green” area, a signal having three sounds in the middle “yellow” area, and a signal having four sounds in the deepest “red” area.

As an alternative, it is naturally also possible to use individual signal generators each having different distances to one another for each layer. For example, two signal generators having the distance X to each other could be arranged in the top layer, two signal generators having the distance 1.5 X to each other could be arranged in the middle layer, and two signal generators having the distance 2.5 X to each another could be arranged in the third, deepest layer. The signal generators are only formed in the respective level. This way, differentiable signals can be generated.

For monitoring the various tires, an individual signal sequence may be assigned to each individual tire, in order to that the sensor, particularly the acoustic sensor, is capable of differentiating the frequencies of all tires. This requires different productions for the tires at the respective positions. Alternatively and preferably, a direction-sensitive sensor, particularly an acoustic sensor, can be used to that end, which is capable of assigning the received signal to the respective tire.

In preferred embodiment of the invention, the signal generators are integrated in a joint element, and said element is arranged in the tire tread. In a method using such a signal element, the advantage is that the tire can first be produced in a normal and conventional manner and the signal element, which is also referred to as resonator, is then bonded or pressed into the tire tread. In this case, elements or recesses are provided in one, two or multiple levels, preferably in two levels or depths, generating a structure-borne sound signal. Here, the signal element is preferably also produced from a natural rubber mix or another material wearing-off in a comparable fashion as the tire or wearing-off faster than the tire per se. Here, said signal elements are preferably pressed or bonded at the base of the tire tread.

Favorably, the signal element is smaller than the tire tread, so that the side of the signal element facing outwards is below the surface of the unused tire tread. Recesses or harder elements can be introduced in the surface of this signal element, preferably recesses generating a signal, preferably a structure-borne sound signal, if the tire tread is worn down to this depth. In a second layer located therebelow are arranged additional signal generators generating a second signal which is different from the first signal of the upper level. For example, the first level could generate a signal of 25 to 30 kHz, and the second level a signal of 50 to 60 kHz. A warning notice indicating that the tire has to be replaced soon is generated for the driver upon detection of the first signal generated on the surface of the signal generator. When reaching the second level, a warning notice it output to the driver, indicating that the tire is to be replaced not later than now. Said signal elements or resonators are preferably integrated into the tire tread on the outer areas of the tire or introduced there, since particularly high wear is to be expected in said regions.

Another aspect of the invention relates to a vehicle which preferably operates on the method described above. Said vehicle having wearing tires, which tires are produced from an elastic material, and having a wear measuring device for the tires, is characterized in that the wear measuring device comprises a plurality of signal generators integrated in the tires, in that a sensor for receiving the signals emitted by the signal generators is provided in the vehicle, and in that a signal processing unit for processing the received signals into useful information for the driver. In such a vehicle, automatically generated information on the wear level of the tires is provided to the driver. In particular, the driver is provided with information indicating that the tire needs to be replaced soon.

The signal generators are preferably arranged in different depths of the tire. As a result, multiple states of the tire or the tread depth can be detected and signalized.

In another preferred embodiment of the invention, the signal generators are arranged at least two times in width direction of the tire next to one another, so that wear can be detected in different areas of the tire. Here, the signal generators can be arranged parallel next to one another or offset next to one another. In this embodiment or further development, respectively, of the invention, it is essential that the signal generators multiply are arranged at different locations of the tread, in order to that a worn-off tread can be detected both in the inner area and the outer area of the running face.

Another aspect of the invention is that the signal generators are formed as elements which can be pressed into the tire. As an alternative, these signal generators can also be generated in the tires during the production process. Said signal generators can be configured as small metal rods or plates. In such a case, they are preferably pressed into the tire. It is also conceivable to form the signal generators from a natural rubber material having different elastic properties than the surrounding natural rubber material and forming them in this way during the production process.

In another preferred embodiment, the signal generators are integrated in one or more signal elements. In particular, all signal generators are preferably arranged in said signal elements. Said signal elements can be introduced in a tire that is produced by means of a conventional method apart from that. This may be effected either in the course of the production process or after that. This comes with the advantage that conventional tires can later be upgraded with such signal generators. Said signal generators are pressed or bonded into the tread at very susceptible positions, preferably in the outer region of the tire or fixed in a different fashion. A tire prepared in this way may comprise recesses at its bottom area or at the tread base, into which protrusions are pressed at the base of the signal element. The signal element preferably has two levels or two depths, in which signal generators are arranged for generating different frequencies. The uppermost level is preferably formed on the surface of the signal element here, wherein the signal element has a smaller total height than the tire tread, in which the signal element is arranged.

As an alternative, it is also conceivable to configure the signal element in its height such that it ends with the tires or the outer face of the tire, respectively. The signal generator is then worn down together with the tire. In this case, the signal generators are to be provided in the desired depths in the signal element. These can either be recesses or harder elements as already described above, which in any case have a degree of hardness different from that of the surrounding signal element and thus generate a signal when in contact to the road surface.

Here, the vehicle preferably is a motor vehicle having pneumatic tires. Basically, the invention may also be applied to other types of vehicles having different tires, e.g. having solid tires. The signal generators preferably generate an acoustic signal, wherein the sensor preferably is an acoustic sensor. Here, the signal generators are preferably configured and/or arranged in different depths such that signals of different frequency are generated by the signal generators. The signal generators need to be arranged in at least two depths in order to distinguish a region having a sufficient tread depth and a region having an insufficient tread depth. The signal generators are preferably arranged in three different depths, so that a region having a good tread depth, a middle region of a sufficient but soon critical tread depth and an area having an insufficient tread depth is indicated. Preferably, an even finer subdivision with four, five, or six depths can be used in order to provide a very detailed information on the available tread depth.

The sensor preferably comprises a piezoelectric element. Said element serves for receiving the acoustic signals. Particularly preferably, the sensor is configured as to allow a directional detection. To that end, the sensor particularly comprises a piezoelectric film. As a result, it is possible to determine the tire that the signal came from among the four tires, so that an individual tread depth can be indicated for each tire.

A further aspect of the invention relates to a tire for use in the above-described vehicle, wherein the tire according to the invention comprises signal generators in different depths.

A further aspect of the invention relates to a signal element for use and for arrangement in a tire, wherein the tire is used in the vehicle described above.

### BRIEF DESCRIPTION OF THE DRAWINGS

In the following, the invention is further described with reference to an exemplary embodiment illustrated in the drawings. The schematic illustrations show in:

FIG. 1: a schematic view of the vehicle according to the invention;

FIG. 2: a perspective view of a tire of the vehicle according to the invention;

FIG. 3: a cross-sectional view through a tread having signal generators illustrated in a stretched manner according to a first embodiment of the invention;

FIG. 4: a cross-sectional view through a tread having signal generators illustrated in a stretched manner according to a second embodiment not the invention;

FIG. 5: a cross-sectional view through a tread having signal generators according to a third embodiment of the invention;

FIG. 6: a cross-sectional view through a tread having signal generators illustrated in a stretched way according to a fourth embodiment of the invention;

FIG. 7: a part-sectional view through a tire with the signal element inserted; and

FIG. 8: a partial-sectional view through a tire with the signal element inverted in a second embodiment.

### DETAILED DESCRIPTION OF THE PREFERRED EMBODIMENTS

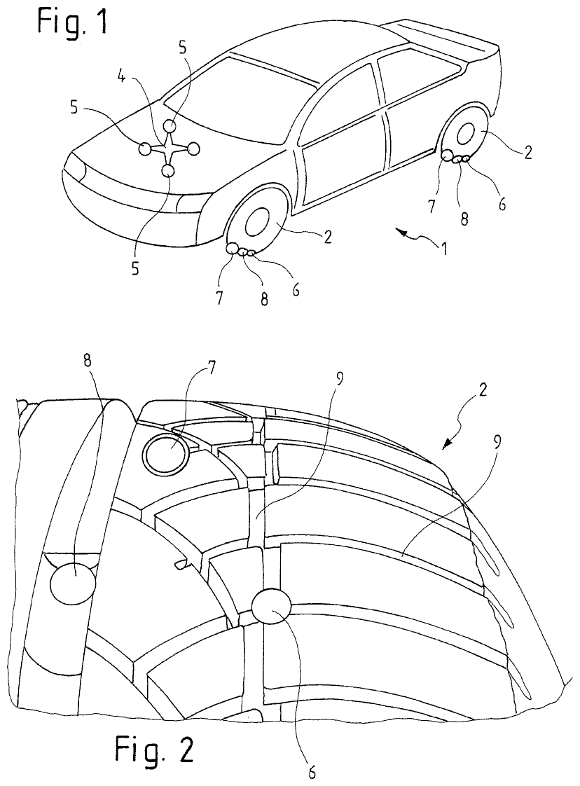

A perspective view of the vehicle 1 according to the invention is illustrated in FIG. 1. Vehicle 1 comprises four tires made of a rubber elastic material. The two tires shown here are indicated at 2. These tires 2 are subject to wear so that the tread of the tires becomes continuously smaller. In order to monitor this, signal generators 6, 7 and 8 are arranged in different depths of the tire, wherein the signal generators 6 are located on the surface of the tire. If the signal generators 6 located in the outer area hit the ground, they generate an acoustic signal. Said acoustic signal is detected by an acoustic sensor 4, which is preferably direction-sensitive, i.e. has a direction sensitivity 5 indicated by the asterisk and thus is able to assign the received sound to a certain tire 2. The received signal is evaluated in consideration of the speed of the vehicle and is made available to the driver. If signals are received by the signal generators 6, this is a sign for that there is a sufficient tread depth. A second group of signal generators is arranged slightly deeper in the tire tread so that if said signal generators 7 are exposed at the surface and generate an acoustic signal when touching the drive lane, said signal is received by the acoustic sensor 4 and finally an information is communicated to the driver, indicating that only a reduced tread depth is still available. In this area, the driver is preferably also provided with information about the kilometers that can be driven with a sufficient tread depth, so that the driver is able to schedule a replacement of the tires. Third signal generators 8 are arranged in the tread base, respectively in the case of an insufficient tread depth according to legal provisions. If the tread 9 is worn-off to such an extent that said signal generators 8 generate an acoustic signal when encountering the drive lane, the driver is finally provided with the information that a sufficient tread depth is longer available.

FIG. 2 illustrates a tire 2 having a tread 9 in a perspective view. In said tire signal generators 6, 7 and 8 are illustrated in different depths. In the embodiment shown, the signal generators are configured as small metal plates, which are pressed into the tire. The offset of signal generators can be discerned as well such that detection possibilities are provided at different locations of the running face. In a further development of the invention, the signal generator 8 would also be arranged also in a right region of the running face, such that it outputs a signal in any case as soon as either the right or the left side of the tread is worn-off accordingly.

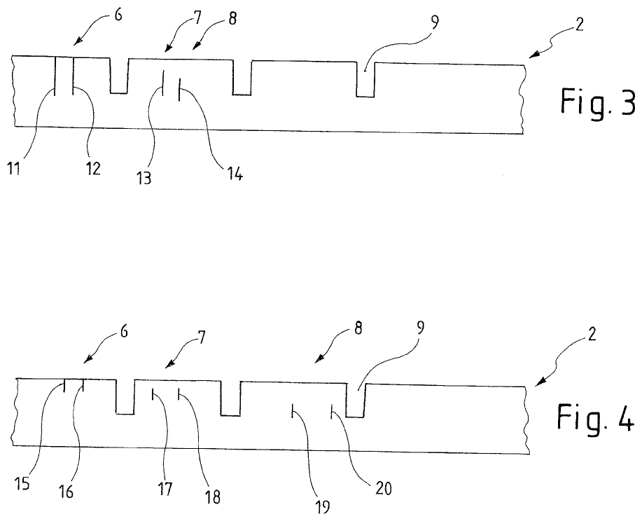

FIG. 3 illustrates a cross-section according to the invention through a tire 2 in an exemplary manner. For simplification purposes, the tread is illustrated in a stretched rather than in a circular view. Tread 9 in the tire 2 can be discerned here. Furthermore, three groups of signal generators 6, 7 and 8 are illustrated. Here, the first group of signal generators 6 comprises two individual signal generators 11 and 12, extending from the surface of the tire to the tread base and thus always emit a kind of base signal, which is detected by the sensor. As long as the tread is hardly worn, the signal is only generated by said two signal generators 11 and 12 of the first group of signal generators 6. With the tread been worn down further, signal generator 13 of the second group 7 of signal generators reaches the surface so that a triple signal is produced then. This signal can then be evaluated such that the tread 9 is worn-off to a middle region and a tire has to be replaced soon. If the tread 9 is further worn down and a critical region is reached, the upper end of the signal generator 14 of the third group of signal generators 8 also reaches the surface, so that a quadruple signal is generated upon rotation of the tire. This is interpreted as a signal indicating that the tire is worn-off too far and has to be replaced now. Of course, multiple individual signal generators can be arranged in the groups of signal generators 7 and 8.

FIG. 4 illustrates a second embodiment of the tire according to the invention. Here, the first group of signal generators 6 comprises two individual signal generators 15 and 16 located on the surface. The depth of these signal generators is limited, and they only extend in an area of a non-critical tread depth. The second group of signal generators 7 consists of signal generators 17 and 18 located in a depth below the signal generators 15 and 16. Here, the distance between signal generators 17 and 18 is 1.5 times the distance between signal generators 15 and 16. The second group of signal generators 7 therefore also generates a double signal, though with a different time signature compared to the group of signal generators 6. Here, the third group of signal generators 8 comprises two single signal generators 19 and 20. Said generators are arranged below the signal generators 17 and 18 and extend down to the tread base 9. In the case that said signal generators of the third group 8 generate a signal, the tread 9 is almost worn-off and the driver is provided the information that a sufficient tread is longer available. The distance of signal generators 19 and 20 is different from the distance of signal generators 15 and 16 and the distance of signal generators 17 and 18. In this case, it is approximately 2.5 times the distance between signal generators 15 and 16. As a result, a unique signal pattern is generated by means of the signal generators of the third group 8. As an alternative, it is naturally possible to arrange a different number of individual signal generators in each individual group of signal generators 6, 7 and 8 in order to generate a different signature.

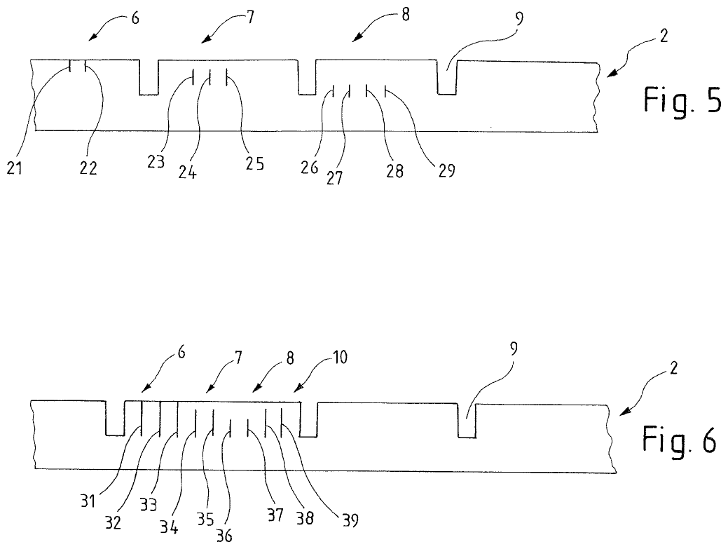

FIG. 5 illustrates a third variant, in which three groups of signal generators 6, 7 and 8 are illustrated. The first group 6 having the signal generators 21 and 22 is directly arranged below the surface of the tread 9. Below said first group, in the second group of signal generators 7 three signal generators 23, 24 and 25 are arranged, indicating here a reduced tread depth, typically between 2 mm and 1.6 mm and which is indicated to the driver preferably by a yellow indicator. In the third tread depth, which is indicated by the third group 8 of signal generators, four signal generators 26, 27, 28 and 29 are provided here. If the tread 9 is worn down so far that the first and second group of signal generators is no longer located on the surface and therefore no longer effective, the four signal generators 26, 27, 28 and 29 are most important, which are then generating a quadruple-group as a signal. In this embodiment, the sensor 5 may thus differentiate between signal groups having two, three and four signals.

In FIG. 6, in turn, illustrates a tire 2 having a straight course, for a better understanding, and a tread 9. The first group 6 of signal generators comprises three individual signal generators 31 and 32 in this case. Said generators extend over the entire tread depth. Upon a certain wear of the tire 2 and thus of the tread 9, the signal generators of the second group 7 of signal generators, namely signal generators 33 and 34, also reach the surface, so that a signal having a total of 5 signals is generated. In the present example, a total of four groups of signal generators is provided. In the present case, furthermore provided is another group 10 of signal generators having an intermediate height, in this case formed by signal generators 37 and 38. If the tread 9 is worn-off a bit deeper, signal generators of groups 6, 7 and 8 and 10 are located on the surface such that a signal of altogether 7 signals is produced then. If the tread 9 is worn-off all the way to the critical region, the signal generators 35 and 36 of the third or in this case fourth group 8 of signal generators are also located on the surface, such that a signal of altogether 9 signal generators is generated, which signal is then detected by the sensors.

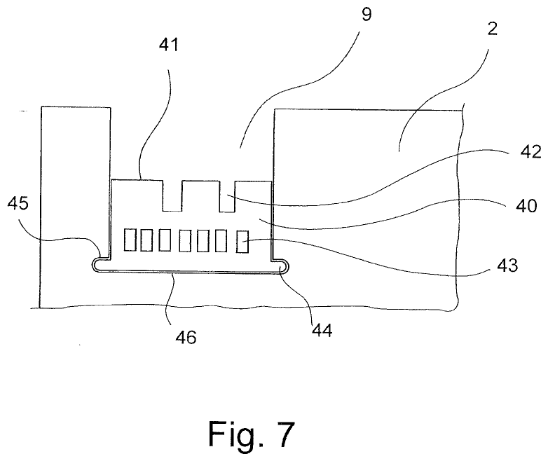

FIG. 7 illustrates a cross-sectional view through a tire 2 having a tread 9. Here, a signal element 40 is placed on the tread base 46. Said element can be bonded or pressed-in. In the exemplary embodiment shown here, recesses 45 are provided in the region of the tread base 46 of the tire, into which protrusions 44 are pressed in the bottom region of signal element 40. The height of the signal element 40 is inferior to the height or depth of the tread 9 in the tire 2, so that the upper edge of the signal element 40 is located below the running face of the tire 2. If the tire 2 is worn-off so far that it is worn-off all the way to the upper edge 41 of the signal element, said upper edge 41 bears on the drive lane together with the signal generators 42 and generate a signal, in particular a structure-borne sound signal. The cross-sectional view illustrated here relates to a cross section in circumferential direction, so that the signal generators 42, which in this case are formed as recesses in the signal element 40, hit the drive lane one after the other, thus producing a signal of a certain frequency, wherein said frequency depends on the drive speed and insofar drive speed is to be considered during evaluation. The structure-borne sound signal is transmitted to the vehicle structure via the rim and the axis and detected and evaluated there by an associated sensor. If the signal generated by signal generators 42 is received, the driver is informed that tire 2 is worn-off to a first level and has to be replaced soon. If then tire 2 is worn-off to a second level, wherein the wear element is also worn-off that far, the signal generators 43 are exposed on the surface and generate a respective signal when touching the drive lane. The number of signal generators 43 has to be different from the number of signal generators 42, in particular the distances of the signal generators 42 to one another and the distance of the signal generators 43 to one another have to be different in order to that the signal element on the second level produces a different signal when compared to the first level. Said signal is transmitted by structure-borne sound and evaluated, and the driver receives the signal that the tire has to be replaced. The signal element(s) 40 is/are preferably arranged in an outer tire region, since wear is most likely to occur there.

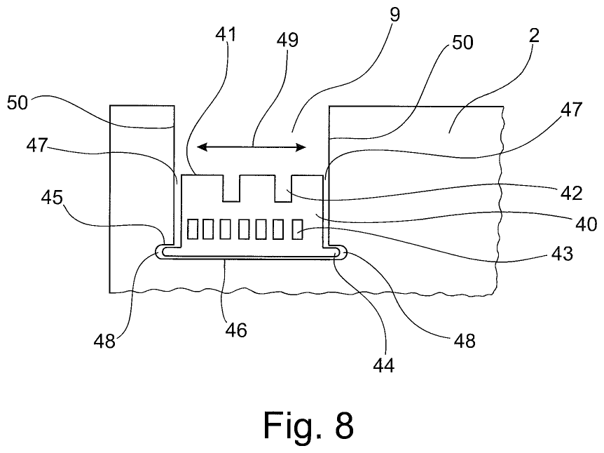

FIG. 8 illustrates an embodiment of the invention similar to FIG. 7. However, it can be seen that the signal element 40 is slightly smaller than the tread 9 in the tire 2 which allows some movement vertical to the running direction as indicated with the arrow 49. Between the signal element 40 and the walls 50 of the tread 9 of the tire 2 there remains a gap 47 which allows such movements. By the collision of the signal element 40 with the surrounding tire 2, in particular the walls 50 of the tread 9 of the tire 2, the structure-borne signal is generated to further enhance the movement. According to arrow 49, the protrusions 44 are slightly smaller than the recesses 45. Within the recesses 45 remains a space 48 which allows further and better movement of the signal element 40.

All features indicated in the above description and in the claims can be combined with the features of the independent claim in any manner. Thus, the disclosure of the invention is not limited to the described or claimed feature combination, rather all reasonable feature combinations within the scope of invention should considered as being disclosed.

1. A vehicle, comprising:
wearing tires made of an elastic material; and
a wear measuring unit for the tires, the wear measuring unit comprising:
a plurality of signal generators are integrated in at least one joined signal element arranged in a tread of the tire, wherein the signal element generates a structure-borne sound signal when the tires are worn-off and when the signal element comes into contact with the street the signal element generates a structure-borne sound signal, wherein the signal element is smaller than the tread of the tire, so that the signal element is able to move within the tread of the tire at least as long as it is not in contact with the street and generates a structure-borne sound signal by its movement within the tread of the tire whereby in the vehicle a sensor for a structure-borne sound signal is provided for receiving the signal emitted by the signal generators; and
a signal processing unit for processing the received signals into information useful for the driver.

2. The vehicle according to claim 1, wherein the signal element, which is arranged in the tread of the tire, has a same cross section in a running direction of the tire.

3. The vehicle according to claim 1, wherein the signal element, which is arranged in the tread of the tire, has a width in a cross section that is smaller than the width of the tire.

4. The vehicle according to claim 1 wherein the signal element has protrusions.

5. The vehicle according to claim 4, wherein the tread of the tire is provided with recesses, which correspond to the protrusions of the signal element.

6. The vehicle according to claim 5, wherein the recesses in the tread of the tire are larger than the corresponding protrusions of the signal element to allow movement of the signal element.

7. A signal element for use in a tread of vehicle according to claim 1.

8. A method for detecting the wear of wearing tires of a vehicle according to claim 1, the method comprising:
emitting signals by the signal elements arranged in the tire treads;
receiving the signals emitting from the signal elements arranged in the tire treads, based on the contact of the signal element with the drive lane;
receiving the signals emitting from the signal elements based on movements of the signal elements within the tire treads; and
processing the information from the two kinds of received signals and making the information available to the driver of the vehicle.

9. The method according to claim 8, wherein the signals based on the contact of the signal processor with the drive lane change discontinuously based on the arrangement of signal processors.

10. The method according to claim 8, wherein the signals based on the movement at the signal element on the tire tread change continuously based on the continuous wear-off of the signal element.

11. The method according to claim 8, wherein a first signal is used to evaluate the wear-off of the tire.

12. The method according to claim 11, wherein the first signal is the signal based on the contact of the signal processor with the drive lane.

13. The method according to claim 8, wherein a second signal based on the movements of the signal elements within the tire treads is used to verify an accuracy of the first signal.

14. The method according to claim 8, wherein a second signal based on the movements of the signal elements within the tire treads is used to verify that the signal elements are still in place within the tire tread.

15. The method according to claim 8, wherein the two kinds of received signals can be differentiated by their amplitude as the signals based on the contact of the signal element with the drive lane is larger than the amplitude of the signal emitting from the signal element based on their movements within the tired treads.
